(19) United States
(12) Patent Application Publication
(10) Pub. No.: US 2018/0018331 A1
(43) Pub. Date: Jan. 18, 2018

(54) CONTEXTUAL SUGGESTIONS FROM USER HISTORY

(71) Applicant: Microsoft Technology Licensing, LLC, Redmond, WA (US)

(72) Inventor: Venkata Pavan Kumar Kesamreddy, Hyderabad (IN)

(73) Assignee: Microsoft Technology Licensing, LLC, Redmond, WA (US)

(21) Appl. No.: 15/208,026

(22) Filed: Jul. 12, 2016

(51) Int. Cl. G06F 17/30

(52) U.S. Cl. CPC G06F 17/3053; G06F 17/30528; G06F 17/3097

(57) ABSTRACT

Non-limiting examples of the present disclosure describe pattern recognition determined based on evaluation of contexts associated with a user history of a user. Input may be received from a processing device of a user. A plurality of contexts associated with user history data of the user history may be evaluated. In examples, the evaluating comprises: generating, for each of the plurality of contexts, a score based on: at least one time period of the user history that is associated with a searching of a context and a frequency of searching for the context within the at least one time period. The evaluating may further comprise ranking the plurality of contexts based on the score corresponding with each of the plurality of contexts. One or more contextual suggestions may be generated and output for the received input based on the ranked plurality of contexts.

### BACKGROUND

Contextual recommendations may be provided by different applications/services. Providing relevant recommendations may present a challenge as intent of a user may be difficult to determine. As an example, a user may begin to enter a query into a search engine and receive inaccurate or non-relevant auto-complete suggestions. In some cases, an application/service may utilize a user's search history in order to attempt to provide relevant recommendations. However, search histories may contain large amounts of contextual data that may present a challenge when utilizing the contextual data to provide recommendations.

As such, examples of the present application are directed to the general technical environment related to improvements in evaluating contexts associated with a history of a user, among other examples.

### SUMMARY

Non-limiting examples of the present disclosure describe pattern recognition determined based on evaluation of context associated with a user history. Contextual suggestions may be generated based on evaluation of different contexts identified in the user history. Input may be received from a processing device of a user. A plurality of contexts associated with a user history may be evaluated. In at least one example, the evaluating of the plurality of contexts may further comprise identifying contexts within a time period of the user history. The evaluating may further comprise generating, for the identified contexts, a score based on at least one time period associated with a searching of a context and a frequency of searching for the context within the at least one time period. In examples, a first weightage is assigned to a time period associated with the context and a second weightage is assigned to the context based on the frequency of searching for the context within the time period. A score for a context is generated based on a processing operation using the first weightage and the second weightage. The evaluating may further comprise ranking the identified contexts based on the score corresponding with each context. One or more contextual suggestions may be output for the received input based on the ranked contexts. In one example, the outputting of the contextual suggestions further comprises displaying one or more contextual suggestions using the processing device of the user.

In one example, one or more auto-complete suggestions are output based on the ranked contexts for the received input. In another example, the outputting described above further comprises: outputting one or more spelling and/or grammatical suggestions for the received input. In yet another example, the outputting as described above further comprises: outputting one or more translational suggestions for voice to text processing of the received input. In further examples, the outputting further comprises: outputting targeted content for the user based on the contextual suggestions. In other examples, targeted content may be created for the user based on the one or more contextual suggestions. The targeted content may be displayed using the processing device of the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 is a block diagram illustrating an example of a computing device with which aspects of the present disclosure may be practiced.

FIGS. 2A and 2B are simplified block diagrams of a mobile computing device with which aspects of the present disclosure may be practiced.

FIG. 3 is a simplified block diagram of a distributed computing system in which aspects of the present disclosure may be practiced.

FIG. 4 is an exemplary method for managing user history data with which aspects of the present disclosure may be practiced.

FIG. 5 is an exemplary method for generation of contextual suggestions with which aspects of the present disclosure may be practiced.

FIG. 6 illustrates an exemplary processing device view of a device executing a search application with which aspects of the present disclosure may be practiced.

FIGS. 7A-7B illustrate exemplary processing device views of a device displaying spelling/grammar suggestions with which aspects of the present disclosure may be practiced.

### DETAILED DESCRIPTION

Non-limiting examples of the present disclosure describe pattern recognition determined based on evaluation of context associated with a user history. Contextual suggestions may be generated based on evaluation of different contexts identified in the user history. A user history comprises user history data. User history data as described herein refers to tracking of any user activity including but not limited to: search log data and associated signal data, click log data (e.g. selected uniform resource locator (URL) data, application access and usage, and correspondence with other users/user accounts, among other examples. It should be understood that tracking of user activity (including user history data as described herein) occurs in compliance with privacy laws protecting sensitive information of users. In examples, a user may be associated with one or more computing devices. For instance, a user may login to single sign-on web service that allows users: network access (including access through distributed networks), application/service access, and access to devices.

In some examples, contexts associated with search log data and/or click log data associated with a user may be evaluated and scored to assist an application/service with providing contextual suggestions that are most relevant to the user. In at least one instance, user history data from other users may also be utilized to provide at least one contextual suggestion for the user. In some examples, signal data associated with user history data may be further utilized to evaluate specific contexts. Exemplary signal data comprises but is not limited to: location data, time/date information, temperature data (associated with a particular location that may be determined from the location data), device information, network data, etc. Evaluation of a user history may comprise executing processing operations that may group user history data according to time slices or time periods. As an example, time periods may be configured to track user activity within a certain amount of time (e.g., 1 minute, 15 minutes, 1 hour, 5 hours, 1 year, etc.). Time periods can be set for any duration of time. In one example, time periods for tracking user activity may be determined using processing operations that apply a Fibonacci series to set time durations for exemplary time periods. However, one skilled in the art that understands the present disclosure should recognize that the duration of time periods can be determined in any of a number of ways including processing operations related to statistical modeling.

Contexts from user activity may be evaluated based on the time periods from which a context is associated. In at least one example, processing operations for evaluating an exemplary user history may comprise: generating, for each of a plurality of contexts, a score based on at least one time period associated with a searching of a context and a frequency of searching for the context within the at least one time period. For instance, search log data and/or click log data for a user may be evaluated (using models that factor in contextual and temporal aspects) to generate contextual suggestions that are tailored for the user. In examples, a first weightage is assigned to the at least one time period and a second weightage is assigned to the context based on the frequency of searching for the context within the at least one time period. Similarly, weightage can be given to the search strings of user searches from five hours ago, ten hours ago, a week ago, year ago, etc. In one example, the weightage is decreased gradually as the search results go back farther in the past (e.g. time period increases). One skilled in the art should recognize that weightages may vary for time periods, contextual frequency, signal data, etc. As an alternative example, a higher weightage may be given to frequency associated with a specific context within a user history, where a system or service may recognize that a user may have repeatedly searched for a specific context. In some examples, modeling to generate a score for evaluating contexts of user search history may balance different aspects of an exemplary user history. When calculating the weightage for contextual evaluation of a user search history, more weightage may be given to the context of the links the user has clicked and lesser weightage should be given to the actual search terms associated with search log data. In examples, a web crawler should maintain a list of weighted contexts of every URL it has indexed, making such a weighting analysis feasible.

In some examples, systems/services may be configured to output a number of contextual suggestions per time period. For instance, in the example where weightages are skewed to give more deference to recent searching, more recent time periods may yield more displayed auto-complete suggestions, for example.

Operations may be applied to evaluate the plurality of contexts, where the processing operations may factor in the weightages when ranking and scoring contexts from user history data. As described above, other factors (such as signal data) may be considered when scoring contexts associated with a user history. For instance, additional weightages may be applied to consider information associated with search entry including but not limited to: location data, time/date information, temperature data (associated with a particular location that may be determined from the location data), device information, and network data, among other examples. Scoring/ranking of context may be performed by executing any of: classification modeling, machine learning processing, deep neural network (DNN) modeling, convolutional neural network (CNN) processing, etc.

A practical example of applying the present disclosure may be the following. Say a search query of “Ant” is entered into a search engine application. Typically, auto-complete suggestions for that query are based on world-wide statistics. However, let's say the user was searching for Java related topics for the past one hour or so. Using operations described in the present disclosure, if a user starts entering “Ant” in the search engine application, the auto-complete suggestions and the search results should factor in the fact that user is looking for an “Ant” programming tool instead of the insect (ant). In another instance, search results data for a query of “Ant” may be arranged based on contextual suggestions determined from evaluating an exemplary user history. In such an example, search results for the “ant” programming tool may be displayed higher than results for the “ant” insect.

Ranking of contexts associated with a user history may be used for any of a number of purposes including but not limited to: generation of contextual suggestions, ranking of search results and generation of targeted content (e.g. content targeted for a user), among other examples. Contextual suggestions include but are not limited to: auto-complete suggestions, spelling and/or grammatical suggestions, translational suggestions (e.g. for voice to text processing), and suggestions for display of targeted content for the user, among other examples.

Accordingly, the present disclosure provides a plurality of technical advantages including but not limited to: generation of improved contextual suggestions that systems, application/services, etc. can utilize to foster better interaction with users, ability to better rank search results for queries, an ability to generate targeted content specific to users, improved organization of a large amount of data associated with a user history for evaluation processing, more efficient operation of processing devices (e.g., saving computing cycles/computing resources) during evaluation of data associated with a user history of a user to generate contextual suggestions, and a system that is scalable to integrate exemplary contextual suggestions within different applications/services among other examples.

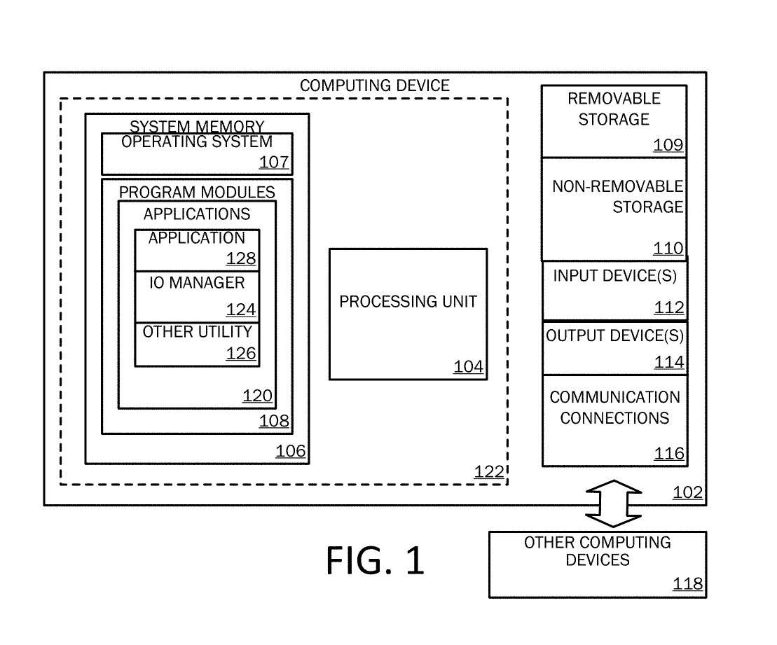

FIGS. 1-3 and the associated descriptions provide a discussion of a variety of operating environments in which examples of the invention may be practiced. However, the devices and systems illustrated and discussed with respect to FIGS. 1-3 are for purposes of example and illustration and are not limiting of a vast number of computing device configurations that may be utilized for practicing examples of the invention, described herein.

FIG. 1 is a block diagram illustrating physical components of a computing device 102, for example a mobile processing device, with which examples of the present disclosure may be practiced. For example, computing device 102 may be an exemplary computing device configured for evaluation of user history data. In a basic configuration, the computing device 102 may include at least one processing unit 104 and a system memory 106. Depending on the configuration and type of computing device, the system memory 106 may comprise, but is not limited to, volatile storage (e.g., random access memory), non-volatile storage (e.g., read-only memory), flash memory, or any combination of such memories. The system memory 106 may include an operating system 107 and one or more program modules 108 suitable for running software programs/modules 120 such as IO manager 124, other utility 126 and application 128. As examples, system memory 106 may store instructions for execution. Other examples of system memory 106 may store data associated with applications. The operating system 107, for example, may be suitable for controlling the operation of the computing device 102.

Furthermore, examples of the invention may be practiced in conjunction with a graphics library, other operating systems, or any other application program and is not limited to any particular application or system. This basic configuration is illustrated in FIG. 1 by those components within a dashed line 122. The computing device 102 may have additional features or functionality. For example, the computing device 102 may also include additional data storage devices (removable and/or non-removable) such as, for example, magnetic disks, optical disks, or tape. Such additional storage is illustrated in FIG. 1 by a removable storage device 109 and a non-removable storage device 110.

As stated above, a number of program modules and data files may be stored in the system memory 106. While executing on the processing unit 104, program modules 108 (e.g., Input/Output (I/O) manager 124, other utility 126 and application 128) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 1 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 102 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 102 may also have one or more input device(s) 112 such as a keyboard, a mouse, a pen, a sound input device, a device for voice input/recognition, a touch input device, etc. The output device(s) 114 such as a display, speakers, a printer, etc. may also be included. The aforementioned devices are examples and others may be used. The computing device 104 may include one or more communication connections 116 allowing communications with other computing devices 118. Examples of suitable communication connections 116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 106, the removable storage device 109, and the non-removable storage device 110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 102. Any such computer storage media may be part of the computing device 102. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

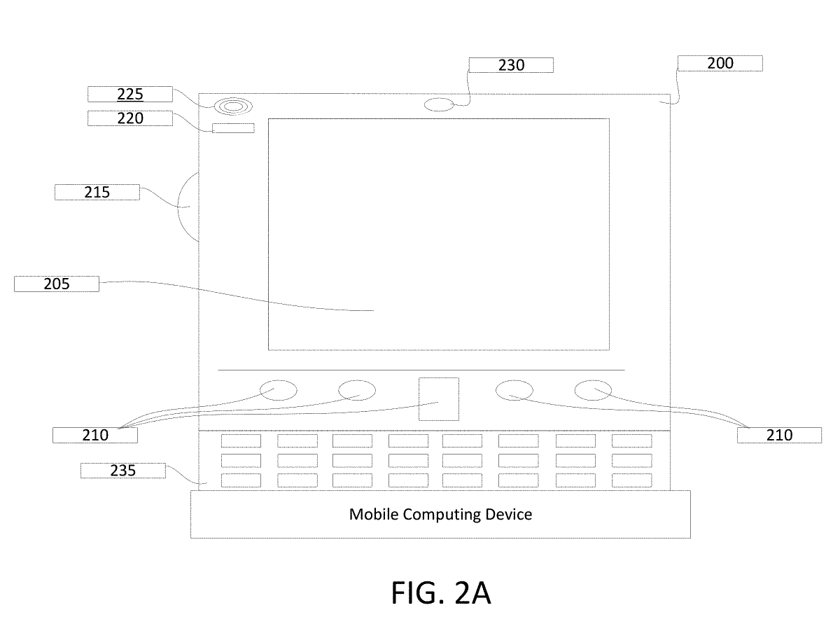

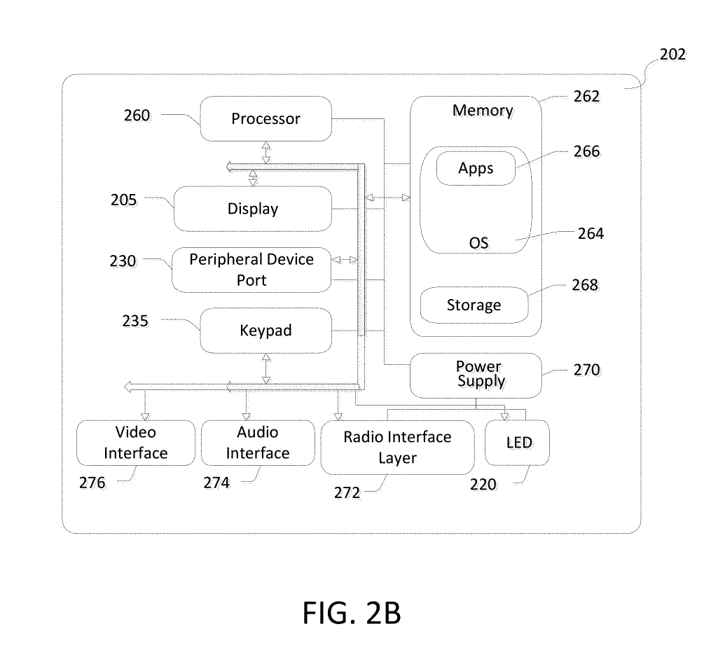

FIGS. 2A and 2B illustrate a mobile computing device 200, for example, a mobile telephone, a smart phone, a personal data assistant, a tablet personal computer, a phablet, a slate, a laptop computer, and the like, with which examples of the invention may be practiced. Mobile computing device 200 may be an exemplary computing device configured for evaluation of user history. With reference to FIG. 2A, one example of a mobile computing device 200 for implementing the examples is illustrated. In a basic configuration, the mobile computing device 200 is a handheld computer having both input elements and output elements. The mobile computing device 200 typically includes a display 205 and one or more input buttons 210 that allow the user to enter information into the mobile computing device 200. The display 205 of the mobile computing device 200 may also function as an input device (e.g., a touch screen display). If included, an optional side input element 215 allows further user input. The side input element 215 may be a rotary switch, a button, or any other type of manual input element. In alternative examples, mobile computing device 200 may incorporate more or less input elements. For example, the display 205 may not be a touch screen in some examples. In yet another alternative example, the mobile computing device 200 is a portable phone system, such as a cellular phone. The mobile computing device 200 may also include an optional keypad 235. Optional keypad 235 may be a physical keypad or a “soft” keypad generated on the touch screen display or any other soft input panel (SIP). In various examples, the output elements include the display 205 for showing a GUI, a visual indicator 220 (e.g., a light emitting diode), and/or an audio transducer 225 (e.g., a speaker). In some examples, the mobile computing device 200 incorporates a vibration transducer for providing the user with tactile feedback. In yet another example, the mobile computing device 200 incorporates input and/or output ports, such as an audio input (e.g., a microphone jack), an audio output (e.g., a headphone jack), and a video output (e.g., a HDMI port) for sending signals to or receiving signals from an external device.

FIG. 2B is a block diagram illustrating the architecture of one example of a mobile computing device. That is, the mobile computing device 200 can incorporate a system (i.e., an architecture) 202 to implement some examples. In one examples, the system 202 is implemented as a “smart phone” capable of running one or more applications (e.g., browser, e-mail, calendaring, contact managers, messaging clients, games, and media clients/players). In some examples, the system 202 is integrated as a computing device, such as an integrated personal digital assistant (PDA), tablet and wireless phone.

One or more application programs 266 may be loaded into the memory 262 and run on or in association with the operating system 264. Examples of the application programs include phone dialer programs, e-mail programs, personal information management (PIM) programs, word processing programs, spreadsheet programs, Internet browser programs, messaging programs, and so forth. The system 202 also includes a non-volatile storage area 268 within the memory 262. The non-volatile storage area 268 may be used to store persistent information that should not be lost if the system 202 is powered down. The application programs 266 may use and store information in the non-volatile storage area 268, such as e-mail or other messages used by an e-mail application, and the like. A synchronization application (not shown) also resides on the system 202 and is programmed to interact with a corresponding synchronization application resident on a host computer to keep the information stored in the non-volatile storage area 268 synchronized with corresponding information stored at the host computer. As should be appreciated, other applications may be loaded into the memory 262 and run on the mobile computing device 200 described herein.

The system 202 has a power supply 270, which may be implemented as one or more batteries. The power supply 270 might further include an external power source, such as an AC adapter or a powered docking cradle that supplements or recharges the batteries.

The system 202 may include peripheral device port 230 that performs the function of facilitating connectivity between system 202 and one or more peripheral devices. Transmissions to and from the peripheral device port 230 are conducted under control of the operating system (OS) 264. In other words, communications received by the peripheral device port 230 may be disseminated to the application programs 266 via the operating system 264, and vice versa.

The system 202 may also include a radio interface layer 272 that performs the function of transmitting and receiving radio frequency communications. The radio interface layer 272 facilitates wireless connectivity between the system 202 and the “outside world,” via a communications carrier or service provider. Transmissions to and from the radio interface layer 272 are conducted under control of the operating system 264. In other words, communications received by the radio interface layer 272 may be disseminated to the application programs 266 via the operating system 264, and vice versa.

The visual indicator 220 may be used to provide visual notifications, and/or an audio interface 274 may be used for producing audible notifications via the audio transducer 225. In the illustrated example, the visual indicator 220 is a light emitting diode (LED) and the audio transducer 225 is a speaker. These devices may be directly coupled to the power supply 270 so that when activated, they remain on for a duration dictated by the notification mechanism even though the processor 260 and other components might shut down for conserving battery power. The LED may be programmed to remain on indefinitely until the user takes action to indicate the powered-on status of the device. The audio interface 274 is used to provide audible signals to and receive audible signals from the user. For example, in addition to being coupled to the audio transducer 225, the audio interface 274 may also be coupled to a microphone to receive audible input, such as to facilitate a telephone conversation. In accordance with examples of the present invention, the microphone may also serve as an audio sensor to facilitate control of notifications, as will be described below. The system 202 may further include a video interface 276 that enables an operation of an on-board camera 230 to record still images, video stream, and the like.

A mobile computing device 200 implementing the system 202 may have additional features or functionality. For example, the mobile computing device 200 may also include additional data storage devices (removable and/or non-removable) such as, magnetic disks, optical disks, or tape. Such additional storage is illustrated in FIG. 2B by the non-volatile storage area 268.

Data/information generated or captured by the mobile computing device 200 and stored via the system 202 may be stored locally on the mobile computing device 200, as described above, or the data may be stored on any number of storage media that may be accessed by the device via the radio 272 or via a wired connection between the mobile computing device 200 and a separate computing device associated with the mobile computing device 200, for example, a server computer in a distributed computing network, such as the Internet. As should be appreciated such data/information may be accessed via the mobile computing device 200 via the radio 272 or via a distributed computing network. Similarly, such data/information may be readily transferred between computing devices for storage and use according to well-known data/information transfer and storage means, including electronic mail and collaborative data/information sharing systems.

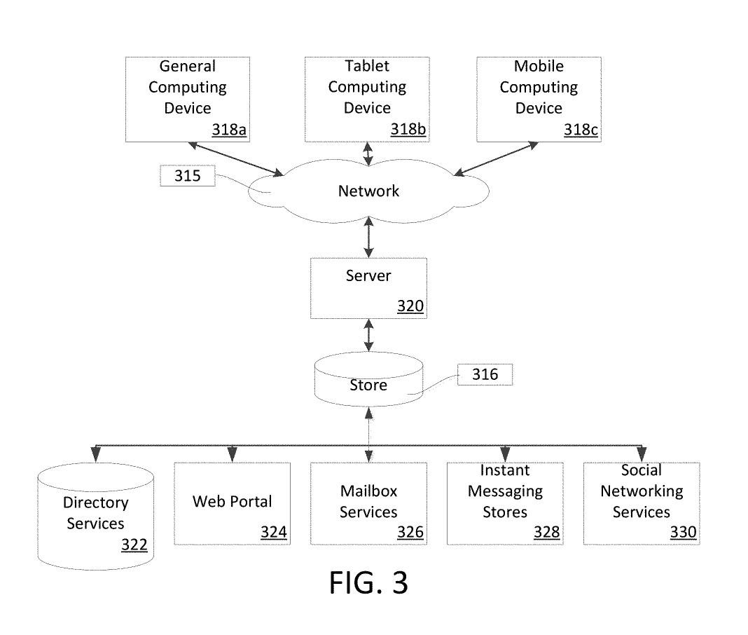

FIG. 3 illustrates one example of the architecture of a system for providing an application that reliably accesses target data on a storage system and handles communication failures to one or more client devices, as described above. The system of FIG. 3 may be an exemplary system configured for evaluation of user history data. Target data accessed, interacted with, or edited in association with programming modules 108, applications 120, and storage/memory may be stored in different communication channels or other storage types. For example, various documents may be stored using a directory service 322, a web portal 324, a mailbox service 326, an instant messaging store 328, or a social networking site 330, application 128, IO manager 124, other utility 126, and storage systems may use any of these types of systems or the like for enabling data utilization, as described herein. A server 320 may provide storage system for use by a client operating on general computing device 102 and mobile device(s) 200 through network 315. By way of example, network 315 may comprise the Internet or any other type of local or wide area network, and client nodes may be implemented as a computing device 102 embodied in a personal computer, a tablet computing device, and/or by a mobile computing device 200 (e.g., mobile processing device). Any of these examples of the client computing device 102 or 200 may obtain content from the store 316.

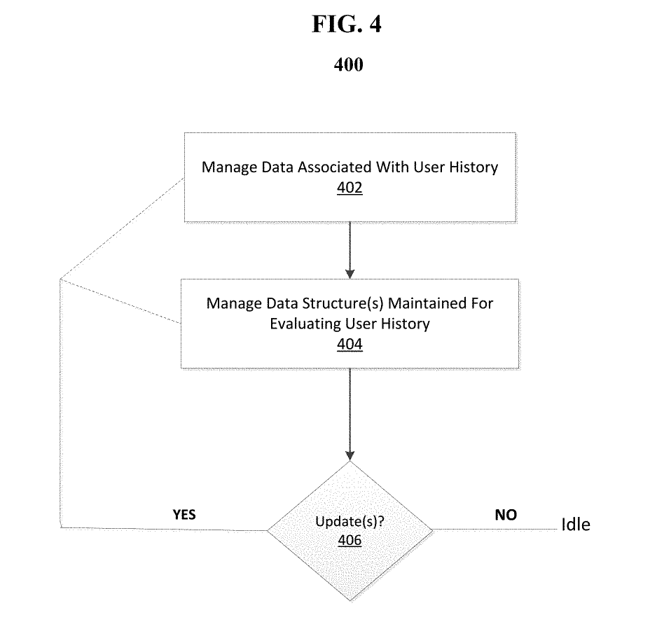

FIG. 4 is an exemplary method 400 for managing user history data with which aspects of the present disclosure may be practiced. As an example, method 400 may be executed by an exemplary processing device and/or system such as those shown in FIGS. 1-3. In examples, method 400 may execute on a device comprising at least one processor configured to store and execute operations, programs or instructions. Operations performed in method 400 may correspond to operations executed by a system and/or service that execute computer programs, application programming interfaces (APIs), neural networks and/or machine-learning processing, among other examples. As an example, processing operations executed in method 400 may be performed by one or more hardware components. In another example, processing operations executed in method 400 may be performed by one or more software components. In some examples, processing operations described in method 400 may be executed by one or more applications/services associated with a web service that has access to a plurality of application/services, devices, knowledge resources, etc.

Method 400 begins at operation 402, where user history data of one or more users may be managed. A corpus of data from one or more user histories may be managed to enable evaluation of the data to generate contextual suggestions for users. An exemplary user history comprises user history data. In one example, only user history data from a single user may be utilized to generate contextual suggestions for that user. In other examples, user history data from other users may be a factor in generating one or more contextual suggestions for the user. For instance, a certain weightage may be allocated to user history data from other users.

User history data as described herein refers to tracking of any user activity including but not limited to: search log data and associated signal data, click log data (e.g. selected uniform resource locator (URL) data, application access and usage, and correspondence with other users/user accounts, among other examples. Storage and management of log data such as data from of a search history may be known to one skilled in the art. It should be understood that tracking of user activity described herein occurs in compliance with privacy laws protecting sensitive information of users. A search history of a user may comprise but is not limited to: search log data and/or click log data. In examples, a user may be associated with one or more computing devices.

In examples, log data associated with a user history of one or more users is maintained. In some examples, user history data may further comprise additional information such as signal data associated with search log data and/or click log data. Exemplary signal data comprises but is not limited to: location data, time/date information, temperature data (associated with a particular location that may be determined from the location data), device information, network data, etc. During evaluation of an exemplary user history, processing operations may be applied to evaluate signal data associated with user history data in order to assist in providing most relevant contextual suggestions for a user. As an example, say a user starts searching/querying for “magnet” at 10:00:00 AM 1 Jan. 2016. In such a case, a log (e.g. identified by a cookie) may be maintained in a search database. Such a log may contain the search term “magnet” and time stamp “10:00:00 AM 1 Jan. 2016”, among other possible types of information that may be associated with a received query such as signal data (described above). Now, let's say the user searches for “magnetic field” at 10:02:30 AM 1 Feb. 2016. In that case, a new log is added to the database with the search text, time stamp, etc. Such a process should be repeated for every search instance.

Flow may proceed to operation 404, where data structures are managed for evaluation of an exemplary user history. In addition to managing user history data, one or more data structures are maintained that may be used in the evaluation of data from a user history. Such data structures may be stored in one or more files that can be stored on one or more computing devices having storage/memory. Exemplary data structures may be associated with computer programs, applications, application programming interfaces (APIs), neural networks, machine learning models, etc., that may utilize the data structures in evaluating data of a user history. An exemplary data structure may contain fields including but not limited to the following:

{
User:[Users cookie] // this will be identification key,
TimeSlice:
{
Past5Searches:{contexts:[{context:”magnets”, weightage:1}],
{TimeSliceWeightage:0.9} }
Past5Minutes:
Past15Minutes:
....
Past1Hour: {contexts:[{context:”magnets”, weightage:0.8},
{context:”electricity”, weightage:0.1} ],
{TimeSliceWeightage:0.75}
...
PastOneYear: {contexts:[{context:”magnets”, weightage:0.5},
{context:”electricity”, weightage:0.3},
[{context:”linear accelerators”, weightage:0.1}, [{context:”icecreams”,
weightage:0.001}], TimeSliceWeightage:0.1}
...
}

However, one skilled in the art should recognize that exemplary data structures can be modified to include more or less data fields. With every new input received including search queries, the one or more data structures for evaluating a user history may be updated to store the various contexts the user is searching for. Contexts from received input may be grouped or arranged in any way. In one example, contexts are stored in a decreasing order of frequency.

Flow may proceed to decision operation 406, where it is determined whether there is an update to one or more of an exemplary user history and an exemplary data structure. If no update occurs to either an exemplary user history or an exemplary data structure, flow branches NO and method 400 remains idle until further input is to be processed. If an update occurs to either an exemplary user history or an exemplary data structure, flow branches YES and returns back to operation to operation 402 (to update of a search history) and/or operation 404 to update an exemplary data structure. In some examples, testing/training operations may occur that may result in modification of data fields of an exemplary data structure or data collected.

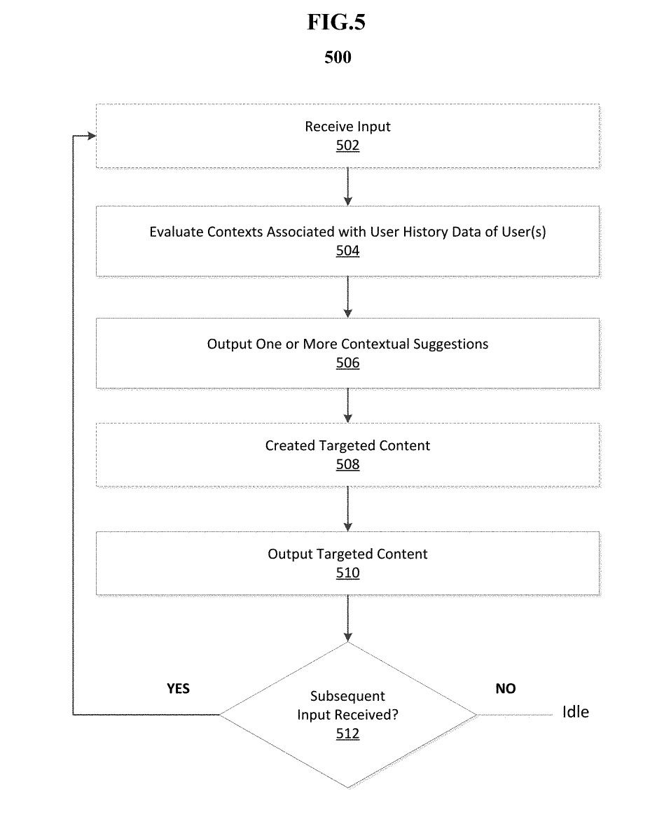

FIG. 5 is exemplary method 500 for generation of contextual suggestions with which aspects of the present disclosure may be practiced. As an example, method 500 may be executed by an exemplary processing device and/or system such as those shown in FIGS. 1-3. In examples, method 500 may execute on a device comprising at least one processor configured to store and execute operations, programs or instructions. Operations performed in method 500 may correspond to operations executed by a system and/or service that execute computer programs, application programming interfaces (APIs), neural networks and/or machine-learning processing, among other examples. As an example, processing operations executed in method 500 may be performed by one or more hardware components. In another example, processing operations executed in method 500 may be performed by one or more software components. In some examples, processing operations described in method 500 may be executed by one or more applications/services associated with a web service that has access to a plurality of application/services, devices, knowledge resources, etc.

Method 500 begins at operation 502, where an input is received. Operations related to input recognition and input understanding processing are known to one skilled in the art. Input may be received in any form including but not limited to: text input, voice input, handwritten input, user interface item selection, etc. In one example, input is received (operation 502) from a processing device of a user. For instance, a user may utilize a processing device to enter an input such as a query, content selection, etc. In one example, user history data may be associated with a particular processing device, where user history data (e.g. including search logs, click logs, etc.) may pertain to searching/selection using the particular processing device. In one such instance, a user profile may be associated with a computing device, where a user history may be associated with a profile of a computing device. In other examples, a user may be signed into a web service that provides access to a plurality of applications/services.

Flow may proceed to operation 504, where contexts associated with user history data may be evaluated. An exemplary user history and associated user have been described in at least the foregoing. Operation 504 may comprise processing operations related to arranging data of a user history, identifying contexts/time periods from the search history, scoring contexts, and ranking contexts based on a score corresponding with a specific context. In examples, a corpus of user history data may be accessed and analyzed in operation 504. The corpus of user history data may comprise user history data for one or more users. Operations described in operation 504 may be performed by executing any of: classification modeling, machine learning processing, deep neural network (DNN) modeling, convolutional neural network (CNN) processing, etc.

Evaluation (operation 504) of a user history may comprise executing processing operations that may group user history data according to time periods/time slices. As an example, time periods may be configured to track user activity within a certain amount of time (e.g., 1 minute, 15 minutes, 1 hour, 5 hours, 1 year, etc.). Time periods can be set for any duration of time. In one example, time periods for tracking user activity may be determined using processing operations that apply a Fibonacci series to set time durations for exemplary time periods. However, one skilled in the art that understands the present disclosure should recognize that the duration of time periods can be determined in any of a number of ways including being randomly generated or generated using processing operations for statistical modeling.

Processing operations executed in the evaluation (operation 504) of user history data may further comprise identifying one or more contexts that is associated with a given time period of the user history data. Operations for identifying and classifying contexts may be executed in real-time, where a data is continuously aggregated when new information is added to user history data for a user. In alternative examples, contexts of data from a user history may be identified in an offline operation.

Evaluating (operation 504) of contexts from a user history may further comprise operations that rank and score the contexts to assist an application/service with providing contextual suggestions. Operation 504 comprises generating, for each of a plurality of contexts, a score based on at least one time period associated with a searching of a context and a frequency of searching for the context within the at least one time period of a user history. Evaluation (operation 504) attempts to identify the most appropriate context for the user (e.g. a received input from a user) by using the weightages of each context in a given time period as well as the weightage of that particular time period from user history data. In examples, a first weightage is assigned to a given time period of user history data and a second weightage is assigned to the context based on the frequency of searching for the context within the given time period. Similarly, weightage can be given to the search strings of user searches from five hours ago, ten hours ago, a week ago, year ago, etc. In one example, the weightage is decreased gradually as the search results go back farther in the past (e.g. time period increases). For instance, if there is a lot of searching for a specific context during an older time period, frequency of searching for that context would be high but weightage applied for scoring would be low. One skilled in the art should recognize that weightages may vary for time periods, contextual frequency, signal data, etc. As an alternative example, a higher weightage may be given to frequency associated with a specific context within a user history, where a system or service may recognize that a user may have repeatedly searched for a specific context. In other examples, systems/services may be configured to output a number of contextual suggestions per time period. For instance, in the example where weightages are skewed to give more deference to recent searching, more recent time periods may yield more displayed auto-complete suggestions, for example.

In some examples, modeling to generate a score for evaluating contexts of user search history may balance different aspects of an exemplary user history. When calculating the weightage for contextual evaluation of a user search history, more weightage may be given to the context of the links the user has clicked and lesser weightage should be given to the actual search terms associated with search log data. In examples, a web crawler should maintain a list of weighted contexts of every URL it has indexed, making such a weighting analysis feasible.

As described above, other factors (such as signal data) may be considered when scoring contexts associated with a user history. For instance, additional weightages may be applied to consider information associated with search entry including but not limited to: location data, time/date information, temperature data (associated with a particular location that may be determined from the location data), device information, and network data, among other examples. For instance, an example input could be a search query that searches for “cool places in the world.” Evaluation of an exemplary search history could yield a determination that search results, auto-complete suggestions, etc., should more prominently display results related to locations with cool (temperature) weather conditions as compared with trending/hip locations. Evaluation of user history data may take into the signal data to determine a current time of the search, date (day, week, month, year etc.) location, current season (e.g. winter, summer, etc.) to determine most relevant contexts for a received input. For instance, when the user enters “cool” during hot time, results/suggestions can be fetched that are related to “cool drinks”. In another instance, if the user is currently located in a place where the temperature is very low, an autosuggest may be “coolest place in the world” etc. Further, patterns in user history data can be identified and utilized to rank contexts for a user. For instance, a pattern of a user might be: on weekdays one might look for work related items and on weekends and during non-office hours the user might be looking for non-work related items. This kind of smart suggestions and search results could be implemented to provide more relevant contextual suggestions for the user at the time the user is searching.

Continuing the example where a user was searching for magnets in previous searches, consider the case where the user keeps on searching for magnets for one hour, and then begins to type an input of “shoe.” In such a case, the evaluating (operation 504) would identify that an appropriate contextual suggestions for the user may be “horseshoe magnet” instead of “sports shoe”. Similar logic can be applied for spell checkers (e.g. in word processing applications), voice to text converters, generation of targeted content for a user, etc.

Flow may proceed to operation 506 where one or more contextual suggestions may be output. As an example, contextual suggestions may be output (operation 506) for a received input. Output (operation 506) of contextual suggestions may be based on the ranked contexts determined in operation 504. As an example, the ranked contextual suggestions may be utilized to arrange search results for a query. In another example, the outputting further comprises outputting one or more auto-complete suggestions for the received input based on the ranked plurality of contexts. In a further example, the outputting further comprises outputting one or more spelling and/or grammatical suggestions for the received input. In yet another example, the outputting further comprises outputting one or more translational suggestions for voice to text processing of the received input. In other examples, the outputting further comprises outputting targeted content for the user based on the contextual suggestions. In one case, output (operation 506) may comprise transmitting one or more contextual suggestions to a computing device such as a computing device of the user for display on the computing device. In another instance, output (operation 506) may comprise displaying the one or more contextual suggestions through a display connected with a computing device.

In some examples, flow may proceed to operation 508, where targeted content may be generated for a user based on ranked contextual suggestions. Examples described herein may interface with a system or service that may generate targeted content for a user. In examples, ranked contextual suggestions may be passed to such a system or service, where the ranked contextual suggestions may be utilized to generate targeted content for a user. In cases where targeted content is generated (operation 508), flow may proceed to operation 510 where the targeted content may be output for display. As an example, operation 510 may comprise displaying the targeted content using the processing device of the user.

Flow may proceed to decision operation 512, where it is determined whether subsequent input is received. If not, flow branches NO and method 500 remains idle until further input is to be processed. If subsequent input is received, flow branches YES and returns back to operation 502 for processing of the subsequent input.

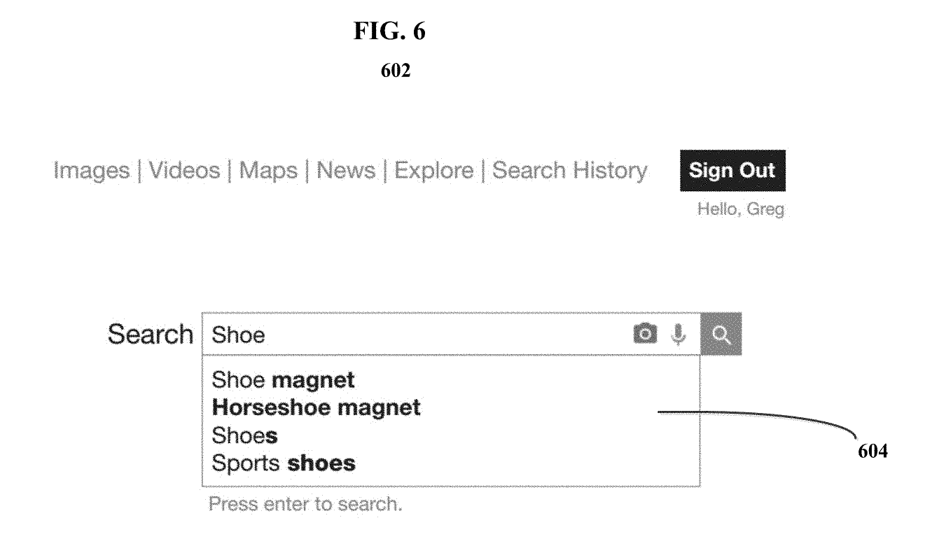

FIG. 6 illustrates an exemplary processing device view 602 of a device executing a search application with which aspects of the present disclosure may be practiced. Processing device view 602 illustrates a user interface result of processing operations executed in the description of method 400 of FIG. 4 and method 500 of FIG. 5. As shown in the upper right-hand portion of processing device view 602, a user named “Greg” is signed into a web service associated with a search application. As illustrated in processing device view 602, a query of “shoe” is entered into a field of the search application resulting in auto-complete suggestions 604 for the query being displayed. As shown in processing device view 602, the auto-complete suggestions 604 are arranged to show that a most relevant context for the query of “shoe” may be magnets, for example, based on evaluation of user history data associated with the user (Greg). One or more additional auto-complete suggestions may also be provided such as shoes, sport shoe, shoe store, etc., which may also be relevant contexts. However, as shown in processing device view 602, display of the auto-complete suggestions 604 may be tailored for relevant contexts associated with a user history.

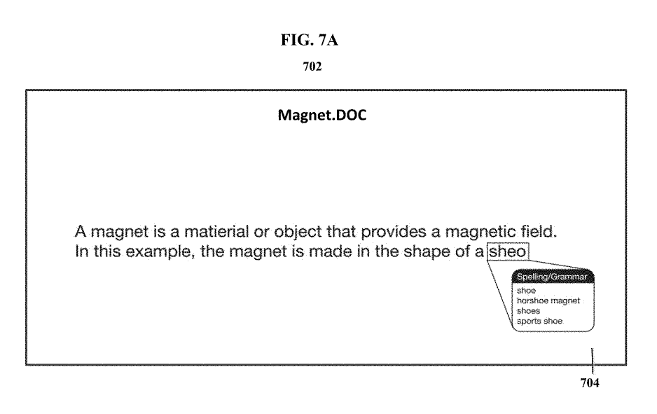

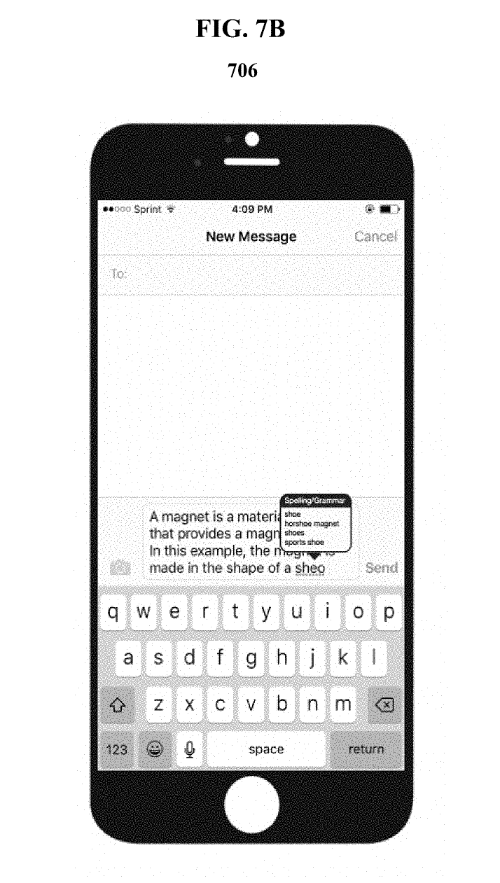

FIGS. 7A-7B illustrate exemplary processing device views of a device displaying spelling/grammar suggestions with which aspects of the present disclosure may be practiced. Processing device view 702 (shown in FIG. 7A) illustrates a front-end user interface result of processing operations executed in one or more of the description of method 400 of FIG. 4 and method 500 of FIG. 5. As illustrated in processing device view 702, a document (e.g. magnet.doc) is displayed in an executing word processing application. While processing device view 702 illustrates a word processing application, one skilled in the art that understands the present disclosure should recognize that functionality described herein can be extended to any type of application. Processing device view 702 highlights functionality of a spelling/grammar corrector that may provide suggestions based on contextual analysis of user history (either associated with a single user, multiple users, processing device, multiple processing devices, etc.). In the example shown, a word of “sheo” is highlighted for spelling/grammar correction. In response to user interaction with a processing device, spelling/grammar suggestions 704 may be presented for the highlighted word. In the example shown in processing device view 702, contextual suggestions, among other examples, may include “shoe” and “horseshoe”. As identified above, contextual analysis of a user history may factor into a determination of the exemplary spelling/grammar suggestions 704.

Processing device view 706 (shown in FIG. 7B) illustrates a front-end user interface result of processing operations executed in one or more of the description of method 400 of FIG. 4 and method 500 of FIG. 5. Description related to implementation of a spelling/grammar description shown has been previously described in the description of FIG. 7A. Processing device view 706 illustrates a spelling/grammar suggestion being displayed in a messaging application.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
receiving input from a processing device of a user;
evaluating a plurality of contexts associated with a user history of the user, wherein the evaluating comprises:
generating, for each of the plurality of contexts, a score based on: at least one time period of the user history that is associated with a searching of a context, and a frequency of searching for the context within the at least one time period,
ranking the plurality of contexts based on the score corresponding with each of the plurality of contexts; and
outputting one or more contextual suggestions for the received input based on the ranked plurality of contexts.

2. The method according to claim 1, wherein a first weightage is assigned to the at least one time period and a second weightage is assigned to the context based on the frequency of searching for the context within the at least one time period, and wherein the generating generates the score for the context based on a processing operation using the first weightage and the second weightage.

3. The method according to claim 1, wherein the evaluating of the plurality of contexts further comprises: identifying one or more of the plurality of contexts within the at least one time period.

4. The method according to claim 1, wherein the outputting further comprises outputting one or more auto-complete suggestions for the received input based on the ranked plurality of contexts.

5. The method according to claim 1, wherein the outputting further comprises outputting one or more selected from a group consisting of: spelling suggestions and grammatical suggestions.

6. The method according to claim 1, wherein the outputting further comprises outputting one or more translational suggestions for voice to text processing of the received input.

7. The method according to claim 1, further comprising creating targeted content for the user based on the one or more contextual suggestions, and displaying the targeted content using the processing device of the user.

8. The method according to claim 1, wherein the outputting further comprises displaying the one or more contextual suggestions using the processing device of the user.

9. A system comprising:
at least one processor; and
a memory operatively connected with the at least one processor storing computer-executable instructions that, when executed by the at least one processor, causes the at least one processor to execute a method that comprises:
receiving input from a processing device of a user,
evaluating a plurality of contexts associated with a user history of the user, wherein the evaluating comprises:
generating, for each of the plurality of contexts, a score based on: at least one time period of the user history that is associated with a searching of a context, and a frequency of searching for the context within the at least one time period,
ranking the plurality of contexts based on the score corresponding with each of the plurality of contexts, and
outputting one or more contextual suggestions for the received input based on the ranked plurality of contexts.

10. The system according to claim 9, wherein a first weightage is assigned to the at least one time period and a second weightage is assigned to the context based on the frequency of searching for the context within the at least one time period, and wherein the generating generates the score for the context based on a processing operation using the first weightage and the second weightage.

11. The system according to claim 9, wherein the evaluating of the plurality of contexts further comprises: identifying one or more of the plurality of contexts within the at least one time period.

12. The system according to claim 9, wherein the outputting further comprises outputting one or more auto-complete suggestions for the received input based on the ranked plurality of contexts.

13. The system according to claim 9, wherein the outputting further comprises outputting one or more selected from a group consisting of: spelling suggestions and grammatical suggestions.

14. The system according to claim 9, wherein the outputting further comprises outputting one or more translational suggestions for voice to text processing of the received input.

15. The system according to claim 9, wherein the method further comprises: creating targeted content for the user based on the one or more contextual suggestions, and displaying the targeted content using the processing device of the user.

16. The system according to claim 9, wherein the outputting further comprises displaying the one or more contextual suggestions using the processing device of the user.

17. A computer-readable storage medium that comprises computer-executable instructions, wherein the computer-executable instructions, when executed by a computing device, cause the computing device to execute a method comprising:
receiving input from a processing device of a user;
evaluating a plurality of contexts associated with user history of the user, wherein the evaluating comprises:
generating, for each of the plurality of contexts, a score based on: at least one time period of the user history that is associated with a searching of a context, and a frequency of searching for the context within the at least one time period,
ranking the plurality of contexts based on the score corresponding with each of the plurality of contexts; and
outputting one or more contextual suggestions for the received input based on the ranked plurality of contexts.

18. The computer-readable storage medium according to claim 17, wherein a first weightage is assigned to the at least one time period and a second weightage is assigned to the context based on the frequency of searching for the context within the at least one time period, and wherein the generating generates the score for the context based on a processing operation using the first weightage and the second weightage.

19. The computer-readable storage medium according to claim 17, wherein the outputting further comprises at least one selected from a group consisting of: outputting one or more auto-complete suggestions for the received input, outputting one or more spelling suggestions for the received input, outputting one or more grammatical suggestions for the received input, outputting one or more translational suggestions for the received input, and outputting targeted content for the user.

20. The computer-readable storage medium according to claim 17, wherein the outputting further comprises displaying the one or more contextual suggestions through the processing device of the user.
